(19) United States
(12) Patent Application Publication
(10) Pub. No.: US 2012/0058036 A1
(43) Pub. Date: Mar. 8, 2012

(54) CO SHIFT CATALYST, METHOD FOR MANUFACTURING THE SAME, AND CO SHIFT REACTOR USING CO SHIFT CATALYST

(75) Inventors: Toshinobu Yasutake, Hiroshima (JP); Tetsuya Imai, Tokyo (JP); Masanao Yonemura, Hiroshima (JP); Susumu Okino, Hiroshima (JP); Keiji Fujikawa, Hiroshima (JP); Shinya Tachibana, Hiroshima (JP)

(73) Assignee: MITSUBISHI HEAVY INDUSTRIES, LTD., Tokyo (JP)

(21) Appl. No.: 13/320,662

(22) PCT Filed: May 15, 2009
(86) PCT No.: PCT/JP2009/059068

§ 371 Date: Nov. 15, 2011

(51) Int. Cl. B01D 53/62; B01D 53/86; B01J 21/04; B01J 37/08; B01J 21/06; B01J 23/63

(52) U.S. Cl. 423/247; 502/339; 502/304; 502/334; 502/332; 502/325; 502/217; 422/168

(57) ABSTRACT

A CO shift catalyst according to the present invention reforms carbon monoxide (CO) and is prepared from one or a mixture of platinum (Pt), ruthenium (Ru), iridium (Ir), and rhodium (Rh) as an active ingredient and at least one of titanium (Ti), aluminum (Al), zirconium (Zr), and cerium (Ce) as a carrier for supporting the active ingredient. The CO shift catalyst can be used in a halogen-resistant CO shift reactor (15) that converts CO contained in gasified gas (12) generated in a gasifier (11) into CO₂.

### FIELD

The present invention relates to a CO shift catalyst that converts CO contained in gasified gas into CO₂, a CO shift reactor using the CO shift catalyst, and a method for purifying gasified gas.

### BACKGROUND

Effective utilization of coal has attracted attention as one of the possible solutions to recent energy issues.

To convert coal to a highly value-added energy medium, advanced technologies, such as a coal gasification technology and a gas purification technology, are required.

An Integrated Coal Gasification Combined Cycle that generates electricity using gasified gas has been proposed (Patent Literature 1).

The Integrated Coal Gasification Combined Cycle (IGCC) is a system that converts coal to combustible gas in a high-temperature and high-pressure gasifier and generates electricity through a combined cycle with a gas turbine and a steam turbine by using the gasified gas as fuel.

An example of the above system is illustrated in FIG. 2. FIG. 2 is an explanatory diagram of a coal gasification power plant according to a conventional technology. A coal gasification power plant 100-1 gasifies coal 101 in a gasifier 102 to obtain gasified gas 103 as synthesis gas, removes dust from the gas in a dust removal apparatus 104, converts COS into H₂S in a COS converter 105, causes a CO shift reaction to occur in a CO shift reactor 106, and recovers CO₂ and removes H₂S in an H₂S/CO₂ recovery apparatus 107. In the figure, a reference numeral 120 denotes air, 121 denotes an air separator, 122 denotes a gasification air compressor, 123 denotes gasification air, 124 denotes steam, and 125 denotes an H₂S/CO₂ treatment system.

Synthesis gas 108 obtained through treatment by the H₂S/CO₂ recovery apparatus 107 is supplied to a combustor 111 in a gas turbine 110 being a power generating means, where the synthesis gas is fired and high-temperature and high-pressure combustion gas is produced. A turbine 112 is driven by the combustion gas. The turbine 112 is connected to a power generator 113 so that the power generator 113 generates electricity when the turbine 112 is driven. Flue gas 114 produced by the driving of the turbine 112 has a temperature of 500 to 600° C. Therefore, it is preferable to feed the flue gas to an HRSG (Heat Recovery Steam Generator (an exhaust heat recovery boiler)) 115 in order to recover heat energy. In the HRSG 115, steam is produced by the heat energy of the flue gas. A steam turbine 116 is driven by the steam. The flue gas whose heat energy is recovered by the HRSG 115 is fed to a denitrification apparatus (not illustrated) to remove NOx from the flue gas and thereafter released into the air through a stack 117.

As described above, for the gasified gas 103 obtained through the gasification in the gasifier 102, the CO shift reactor 106 that converts CO contained in the gasified gas into CO₂ is needed before the CO₂ is separated.

The CO shift reaction is performed to obtain CO₂ and H₂ as useful components as expressed by the following Expression (1).

CO+H₂O→CO₂+H₂ (1)

Various CO shift catalysts have been proposed as catalysts for promoting the CO shift reaction. Examples of the catalysts include an aluminum oxide supported molybdenum (Mo)—cobalt (Co) based catalyst and an aluminum oxide supported copper (Cu)—zinc (Zn) based catalyst.

The CO shift reactor 106 converts a large amount of CO contained in the gasified gas 103 into H₂. Therefore, it is possible to obtain not only gas used for turbines but also purified gas having a composition suitable for the synthesis of chemical products, such as ethanol or ammonia.

### Citation List

### Patent Literature

Patent Literature 1: Japanese Patent Application Laid-open No. 2004-331701

Patent Literature 2: Japanese Patent Publication No. S59-2537

### SUMMARY

### Technical Problem

Co—Mo based catalysts have been proposed as conventional CO shift catalysts. However, the Co—Mo based catalysts have a problem in that a reaction temperature to be used is as high as 350° C. and the amount of input of the steam 124 to be used significantly increases, so that it is impossible to save energy. Meanwhile, the Co—Mo based catalysts have advantages in that they can be used in a sulfur component (S component) atmosphere.

By contrast, a reaction temperature of the Cu—Zn based catalysts to be used is as low as about 300° C. or lower, so that the energy efficiency of the gas purification system is good. However, there is a problem in that the Cu—Zn based catalysts are poisoned in the sulfur component (S component) atmosphere and cannot be used when gas is not purified as in the coal gasification power plant 100-1 illustrated in FIG. 2.

A conventional technology has been proposed in which, as in a coal gasification power plant 100-2 illustrated in FIG. 3, a poisoning component is removed before a CO shift reaction and then the CO shift reaction is caused to occur.

That is, as illustrated in FIG. 3, in the coal gasification power plant 100-2 used for the Cu-Zn based catalysts, the CO shift reactor 106 is installed on the downstream side of the H₂S/CO₂ recovery apparatus 107 so that a gas purification treatment is performed on gasified gas by causing the CO shift reaction to occur after gas is purified.

However, in the coal gasification power plant 100-2 illustrated in FIG. 3, there is a problem in that the temperature of the gas purified by the H₂S/CO₂ recovery apparatus 107 needs to be increased again to near 300° C., which is disadvantageous in terms of the thermal efficiency of the gas purification system.

Therefore, there is a demand for a CO shift catalyst that can ensure good energy efficiency of the gas purification system, that has activity at a low temperature, and that is resistant to the sulfur atmosphere.

In view of the above problem, it is an object of the present invention to provide a CO shift catalyst that can ensure good energy efficiency of a system, that is active at a low temperature, and that is resistant to the sulfur atmosphere; a method for manufacturing the CO shift catalyst; a CO shift reactor using the CO shift catalyst, and a method for purifying gasified gas.

### Solution to Problem

According to an aspect of the present invention, a CO shift catalyst that reforms carbon monoxide (CO) in a gas includes: one or a mixture of platinum (Pt), ruthenium (Ru), iridium (Ir), and rhodium (Rh) as an active ingredient; and at least one of titanium (Ti), aluminum (Al), zirconium (Zr), and cerium (Ce) as a carrier for supporting the active ingredient.

Advantageously, in the CO shift catalyst, the carrier is a complex oxide of at least two types of elements.

Advantageously, in the CO shift catalyst, an additive amount of the active ingredient is 0.01 to 5% by weight.

Advantageously, in the CO shift catalyst, the CO shift catalyst is prepared by causing sulfate radical to remain therein.

According to another aspect of the present invention, a method of manufacturing a CO shift catalyst includes: adding sulfuric acid to an oxide of one of titanium (Ti), aluminum (Al), zirconium (Zr), and cerium (Ce) or to a complex oxide of at least two of titanium (Ti), aluminum (Al), zirconium (Zr), and cerium (Ce); evaporating moisture from the oxide or the complex oxide to which the sulfuric acid is added at the adding; firing the oxide or the complex oxide, from which the moisture is evaporated at the evaporating, in a heating furnace at a temperature of 500 to 600° C. to cause sulfate radical to remain in a carrier; and causing the carrier, in which the sulfate radical remains, to support an active ingredient.

Advantageously, in the method, the active ingredient is one of or a mixture of platinum (Pt), ruthenium (Ru), iridium (Ir), and rhodium (Rh).

According to still another aspect of the present invention, a CO shift reactor comprising a reactor that is filled with any one of the CO shift catalyst described above.

According to still another aspect of the present invention, a method for purifying gasified gas includes: removing soot and dust from gasified gas containing halide by using a filter, the gasified gas being obtained by a gasifier; causing a CO shift reaction to occur by using any one of the CO shift catalyst described above; cleaning the gasified gas by a wet scrubber after the CO shift reaction; and removing carbon dioxide from the gasified gas after the cleaning.

### Advantageous Effects of Invention

According to the present invention, it is possible to cause a CO shift reaction to occur at a low temperature and improve energy saving.

### BRIEF DESCRIPTION OF DRAWINGS

FIG. 1 is a schematic diagram of a gasified gas purification system that includes a CO shift reactor filled with a CO shift catalyst according to an embodiment.

FIG. 2 is an explanatory diagram of a gasified gas purification system that includes a CO shift reactor filled with a CO shift catalyst according to a conventional technology.

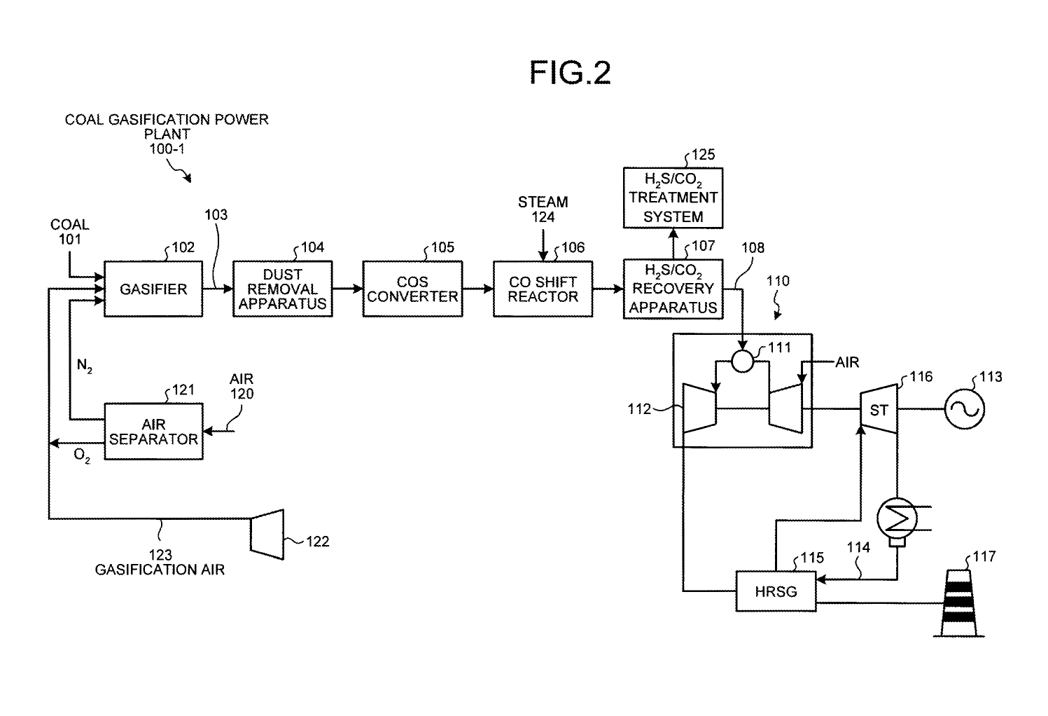

FIG. 3 is an explanatory diagram of a gasified gas purification system that includes a CO shift reactor filled with another CO shift catalyst according to the conventional technology.

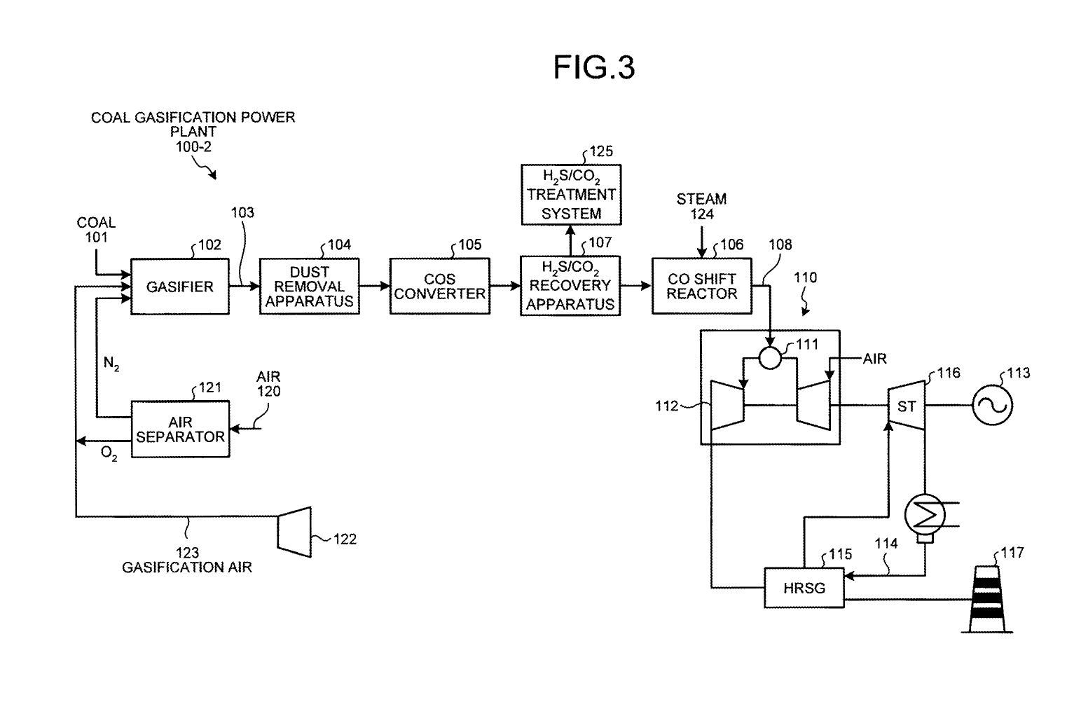

### REFERENCE SIGNS LIST

10 gasified gas purification system

11 gasifier

12 gasified gas

13 filter

14 CO shift catalyst

15 CO shift reactor

16 wet scrubber

17 first heat exchanger

18 gas purification apparatus

### DESCRIPTION OF EMBODIMENTS

Hereinafter, the present invention will be described in detail with reference to the drawings.

However, the present invention is not limited to embodiments described below. The components in the following embodiments include those readily apparent to persons skilled in the art and those substantially similar thereto.

### Embodiments

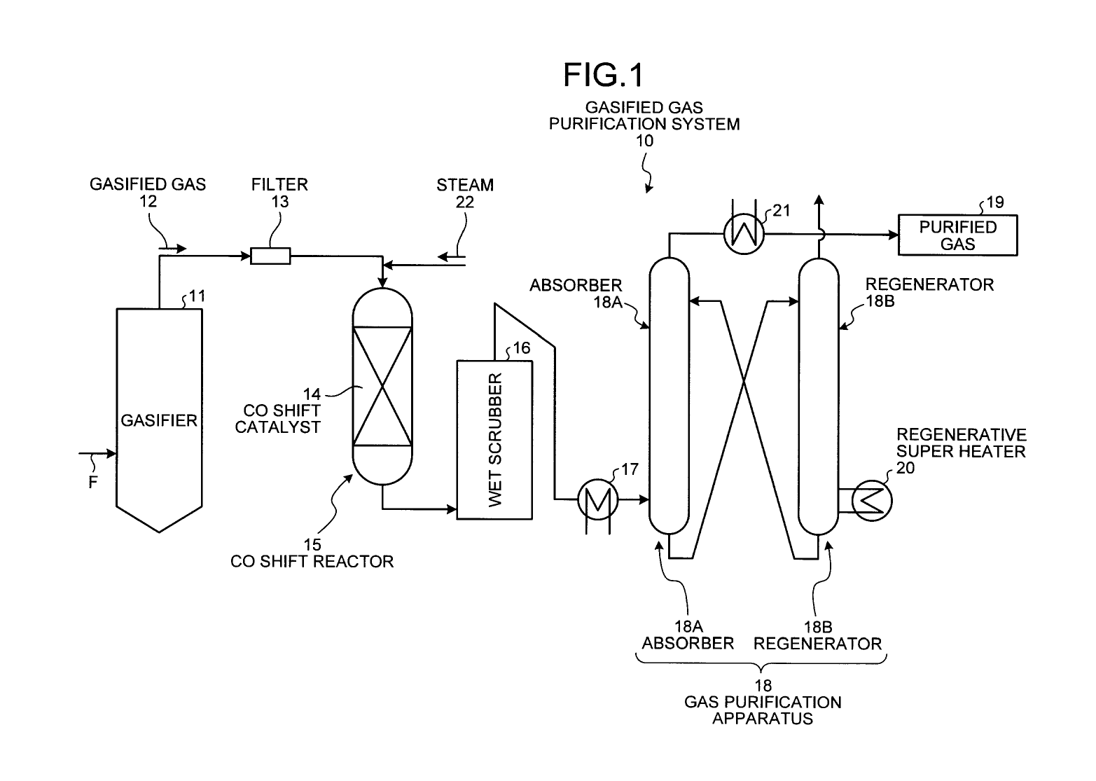

A CO shift catalyst and a CO shift reactor using the CO shift catalyst according to embodiments of the present invention will be described with reference to the drawings. FIG. 1 is a schematic diagram of a gasified gas purification system that includes a CO shift reactor filled with a CO shift catalyst.

As illustrated in FIG. 1, a gasified gas purification system 10 includes a gasifier 11 that gasifies coal as fuel F; a filter 13 that removes soot and dust from gasified gas 12 that is synthesis gas; a CO shift reactor 15 with a CO shift catalyst 14 that converts CO contained in the gasified gas 12 into CO₂; a wet scrubber 16 that removes halogen from the gasified gas 12 after the CO shift reaction; a first heat exchanger 17 that lowers the temperature of the gasified gas 12; and a gas purification apparatus 18 that includes an absorber 18A for absorbing CO₂ contained in the gasified gas 12 after heat exchange and a regenerator 18B for recovering the CO₂.

In FIG. 1, a reference numeral 20 denotes a regenerative super heater, 21 denotes a second heat exchanger for heating purified gas 19, and 22 denotes steam.

A CO shift catalyst according to the present invention is a CO shift catalyst that reforms carbon monoxide (CO) contained in gas and is prepared from any one of or a mixture of platinum (Pt), ruthenium (Ru), iridium (Ir), and rhodium (Rh) as an active ingredient and any one of titanium (Ti), aluminum (Al), zirconium (Zr), and cerium (Ce) as a carrier for supporting the active ingredient.

By using any one of titanium (Ti), aluminum (Al), zirconium (Zr), and cerium (Ce) as the carrier, it is possible to provide a catalyst that has excellent activity at a low temperature. Therefore, it becomes possible to efficiently promote a CO shift reaction even when the amount of steam is reduced (for example, when the CO shift reaction is caused to occur after the temperature is greatly lowered from 350° C. to about 250° C.)

This is because, as will be shown in test examples described below, supporting a small amount of metal, such as Pt, allows for good catalytic activation even when a catalyst has a low-temperature activity and is in the S-atmosphere.

It is preferable to use any of oxides TiO₂, Al₂O₃, ZrO₂, and CeO₂ as the carrier.

The carrier may be a complex oxide containing at least any two of the above elements or more than two of the above elements. Furthermore, the carrier may be a combination of the complex oxide and any mixture.

Examples of the complex oxide obtained as above include TiO₂—ZrO_{2, TiO}₂—Al₂O₃, TiO₂—CeO₂, CeO₂—ZrO₂, and ZrO₂—Al₂O₃.

The additive amount of the active ingredient, which is any one of or a mixture of platinum (Pt), ruthenium (Ru), iridium (Ir), and rhodium (Rh), is preferably 0.01 to 5% by weight, and more preferably, 0.01 to 0.5% by weight.

The catalyst according to the present invention is subjected to sulfuric acid treatment in order to be resistant to a sulfur component.

The sulfuric acid treatment is a treatment method in which a catalyst is immersed in a sulfuric acid aqueous solution, such as sulfuric acid or thiosulfuric acid, dried, and then further dried in a heating furnace in the high-temperature atmosphere (about 500 to 600° C.) to cause sulfate radical to remain in the catalyst.

As a specific treatment method, a catalyst is introduced into 1 molar concentration of sulfuric acid, filtered, dried, and fired at 600° C.

Examples of the sulfate radical or a precursor of the sulfate radical include sulfuric acid (H₂SO₄), ammonium sulfate [(NH₄)₂SO₄], ammonium sulfite [(NH₄)₂SO₃], ammonium hydrogen sulfate [(NH₄)HSO₄], and sulfuryl chloride (SO₂Cl₂).

In particular, sulfuric acid, ammonium sulfate, and sulfuryl chloride are more preferable.

Examples of a method for containing sulfate radical include a method in which a dry hydroxide or dry oxide belonging to group III (and/or group IV metal) is immersed or is caused to flow down so as to come into contact with 1 to 10 parts by weight of 0.01 to 10 molar concentration, or more preferably 0.1 to 5 molar concentration, of a solution containing sulfate radical.

According to the present invention, it is possible to cause a CO shift reaction to occur at a low temperature and with a reduced amount of supply of steam in the CO shift reactor 15 having the CO shift catalyst 14, purify the gasified gas in the wet scrubber 16 after the CO shift reaction, and remove carbon dioxide from the gasified gas, thereby obtaining the purified gas 19.

In FIG. 1, the gasified gas 12 from the gasifier 11 has a high temperature of 350° C. and the CO shift reactor 15 causes the CO shift reaction to occur while the gas temperature is maintained. Therefore, it is possible to perform the CO shift reaction at a lowered gas temperature of 300° C. or lower (more preferably, around 250° C.)

Thereafter, the gas temperature is lowered in the wet scrubber 16, halide is removed from the gas, and the gas is purified in the gas purification apparatus 18 that includes the absorber 18A and the regenerator 18B. Therefore, unlike the conventional technology, it is not necessary to lower the temperature once in a scrubber and then increase the temperature again to cause the CO shift reaction to occur in the CO shift reactor 106. Consequently, it is possible to construct a system structure having improved energy efficiency.

As described above, according to the CO shift catalyst of the present invention, it is possible to cause a shift reaction to occur while reducing the amount of steam and saving energy when the gasification is performed in a coal gasifier. Therefore, it is possible to provide a highly-efficient gas purification process with good thermal efficiency.

### Test Examples

Hereinafter, test examples indicating the advantageous effects of the present invention will be described.

### Method for Manufacturing a Catalyst

### Test Example 1-1

49.5 g of titanium dioxide manufactured by ISHIHARA SANGYO KAISYA, LTD. (TiO₂ (product name: “MC-90”)) was put in a porcelain dish, a diammine dinitro platinum nitric acid solution dissolved in 50 ml of water was added so that 1 wt % of Pt was obtained with respect to the total amount of resultant powder. Thereafter, evaporation to dryness 1-and impregnation were performed on the contents of the porcelain dish. The obtained powder was completely dried by a drier and thereafter fired at 500° C. for 3 hours (the rate of temperature rise was 100° C./h), so that a powdered catalyst 1-1 was obtained.

The obtained powdered catalyst 1-1 was put into a 30-ton pressing machine to immobilize the powder, crushed so that a particle diameter was in a range from 2 to 4 mm, and sifted. Thereafter, the powder was immersed in 100 ml of 1 mol % of a sulfuric acid aqueous solution, evaporated to dryness, fired at 600° C. for 3 hours, and subjected to sulfuric acid treatment, so that a catalyst 1-1 (the catalytic component: Pt; and the carrier component: TiO₂) was obtained.

### Test Example 1-2 to Test Example 1-4

The supported amount of Pt used in the test example 1 was changed to 0.01 wtl, 0.1 wt %, or 5 wt %. Other than the above, the same operations as those of the test example 1 were performed to obtain powdered catalysts 1-2 to 1-4. Each of the obtained powdered catalysts 1-2 to 1-4 was put into a 30-ton pressing machine to immobilize the powder, crushed so that a particle diameter was in a range from 2 to 4 mm, and sifted. Thereafter, the powder was immersed in 100 ml of 1 mol % of a sulfuric acid aqueous solution, evaporated to dryness, fired at 600° C. for 3 hours, and subjected to sulfuric acid treatment, so that catalysts 1-2 to 1-4 (the catalytic component: Pt; and the carrier component: TiO₂) were obtained.

### Test Example 2 to Test Example 10

Compositions and materials for test examples were changed as shown in Table 1. Other than the above, the same operations as those of the test example 1 were performed to obtain catalyst powders 2 to 10.

Each of the obtained catalyst powders 2 to 10 was put into a 30-ton pressing machine to immobilize the powder, crushed so that a particle diameter was in a range from 2 to 4 mm, and sifted. Thereafter, the powder was immersed in 100 ml of 1 mol % of a sulfuric acid aqueous solution, evaporated to dryness, fired at 600° C. for 3 hours, and subjected to sulfuric acid treatment. As a result, a catalyst 2 (the catalytic component: Pt; and the carrier component: CeO₂); a catalyst 3 (the catalytic component: Pt; and the carrier component: ZrO₂); a catalyst 4 (the catalytic component: Pt; and the carrier component: AlO₃); a catalyst 5 (the catalytic component: Ru; and the carrier component: ZrO₂/Al₂O₃); a catalyst 6 (the catalytic component: Ru; and the carrier component: CeO₂); a catalyst 7 (the catalytic component: Ir; and the carrier component: Al₂O₃); a catalyst 8 (the catalytic component: Pt; and the carrier component: ZrO₂/TiO₂); a catalyst 9 (the catalytic component: Ru; and the carrier component: ZrO₂); and a catalyst 10 (the catalytic component: Ru; and the carrier component: ZrO₂) were obtained.

### Comparative Example 1

A catalyst that had the same composition as that of the catalyst powder 3 of the test example 3 and that was not subjected to the sulfuric acid treatment after crushing and sifting was prepared as a comparative catalyst 1.

### Comparative Example 2

83.3 g of Al₂O₃ manufactured by HAYASHI PURE CHEMICAL IND., LTD. was put in a porcelain dish, cobalt nitrate hexahydrate and ammonium molybdate tetrahydrate dissolved in 100 ml of water were added so that 4 wt % of CoO and 13 wt % of MoO₃ were supported with respect to the total amount of resultant powder. Thereafter, evaporation to dryness and impregnation were performed on the contents of the porcelain dish. The obtained powder was completely dried by a drier and thereafter fired at 500° C. for 3 hours (the rate of temperature rise was 100° C./h), so that a comparative catalyst powder 2 was obtained.

The obtained catalyst powder 1-1 was put into a 30-ton pressing machine to immobilize the powder, crushed so that a particle diameter was in a range from 2 to 4 mm, and sifted, so that a comparative catalyst 2 was obtained.

### Comparative Example 3

An alkaline solution A was prepared by dissolving 2.5 mol % of sodium carbonate in 2 L of water and maintaining the temperature of the solution at 60° C. An acid solution B was prepared by dissolving 0.123 mol of aluminum nitrate and 0.092 mol of zinc nitrate in 400 ml of water and maintaining the temperature of the solution at 60° C. An acid solution C was prepared by dissolving 0.22 mol of cupric nitrate in 400 ml of water and maintaining the temperature of the solution at 60° C.

Droplets of the solution B were uniformly added to the solution A for 30 minutes while the mixture was kept stirred, so that a precipitate-produced solution D was obtained. Then, droplets of the solution C were uniformly added to the precipitate-produced solution D for 30 minutes, so that a precipitate-produced solution F containing aluminum, zinc, and copper was obtained.

The precipitate-produced solution F was aged by being stirred for 2 hours, and filtrate obtained from the precipitate-produced solution F was adequately cleaned so that Na ion and NO ion were not detected. Then, the resultant solution was dried at 100° C. for 24 hours and fired at 300° C. for 3 hours, so that a comparative catalyst powder was obtained. This comparative catalyst powder is described as a comparative catalyst powder 3.

The obtained comparative catalyst powder 3 was put into a 30-ton pressing machine to immobilize the powder, crushed so that a particle diameter was in a range from 2 to 4 mm, and sifted, so that a comparative catalyst 3 was obtained.

The tests were performed as follows. 15.8 cc of a catalyst was added to a tubular reaction tube with an inner diameter of 20 mm, and the catalytic activity was evaluated by a device that can control gas compositions and a gas flow rate by a mass flow controller and that can control the temperature of a catalytic layer by an electric furnace.

The evaluation conditions were as follows: H₂/CO/CO₂=30/50/20 mol %; S/CO=2.0; the pressure was 0.1 PMa; and the temperature was 350° C. The amount of gas was 1500 h⁻¹ (23.7 L/h).

The catalytic activities were compared with one another based on the following CO conversion rate as a parameter defined by a change in the gas flow rate between an inlet and an outlet of the catalytic layer.

The CO conversion rate (%)=(1−(the CO gas flow rate (mol/h) at the outlet of the catalytic layer)/(the CO gas flow rate (mol/h) at the inlet of the catalytic layer).

As the hydrogen-chloride exposure test, the CO conversion rate was obtained after exposure for 150 hours at the HCl concentration of 100 ppm.

A list of the catalysts are shown in Table 1.

The test results are shown in Table 2.

TABLE 1
List of catalysts

| | Catalytic component | | | | |
|---|---|---|---|---|---|
| | Noble metal | | | | |
| | | | Supported | | Carrier |
| Catalyst | | | amount | S | component |
| No. | Component | Material | (wt %) | treatment | (oxide) |
| 1-1 | Pt | Diammine dinitro | 1 | Yes | TiO₂ |
| | | platinum nitric acid | | | |
| | | solution | | | |
| 1-2 | Pt | Diammine dinitro | 0.01 | Yes | TiO₂ |
| | | platinum nitric acid | | | |
| | | solution | | | |
| 1-3 | Pt | Diammine dinitro | 0.1 | Yes | TiO₂ |
| | | platinum nitric acid | | | |
| | | solution | | | |
| 1-4 | Pt | Diammine dinitro | 5 | Yes | TiO₂ |
| | | platinum nitric acid | | | |
| | | solution | | | |
| 2 | Pt | Diammine dinitro | 0.5 | Yes | CeO₂ |
| | | platinum nitric acid | | | |
| | | solution | | | |
| 3 | Pt | Diammine dinitro | 0.1 | Yes | ZrO₂ |
| | | platinum nitric acid | | | |
| | | solution | | | |
| 4 | Pt | Diammine dinitro | 0.05 | Yes | Al₂O₃ |
| | | platinum nitric acid | | | |
| | | solution | | | |
| 5 | Ru | Ruthenium nitrate | 0.5 | Yes | ZrO₂/ |
| | | | | | Al₂O₃ |
| 6 | Rh | Rhodium nitrate | 0.1 | Yes | CeO₂ |
| 7 | Ir | Iridium nitrate | 0.5 | Yes | Al₂O₃ |
| 8 | Pt | Diammine dinitro | 0.05 | Yes | ZrO₂/TiO₂ |
| | | platinum nitric acid | | | |
| | | solution | | | |
| 9 | Ru | Ruthenium nitrate | 0.5 | Yes | ZrO₂ |
| 10 | Ru | Ruthenium nitrate | 0.05 | Yes | ZrO₂ |
| Comparative | Pt | Diammine dinitro | 0.1 | No | ZrO₂ |
| example 1 | | platinum nitric acid | | | |
| | | solution | | | |
| Comparative | Co—Mo | | | No | Al₂O₃ |
| example 2 | | | | | |
| Comparative | Cu—Zn | | | No | Al₂O₃ |
| example 3 | | | | | |

TABLE 2
Result of property and activity evaluation

| | | | | | | CO | |
|---|---|---|---|---|---|---|---|
| | Catalytic component | | | | | conversion | |
| | Noble metal | | | | Specific | rate at 200° C. | |
| | | Supported | | Carrier | surface | Initial | Resistance |
| Catalyst | | amount | S | component | area | state→4 | to Cl HCl 100 |
| No. | Component | (wt %) | treatment | (oxide) | (m²/g) | hours after | ppm, 150 h |
| 1-1 | Pt | 1 | Yes | TiO₂ | 55 | 76→71 | 76→71 |
| 1-2 | Pt | 0.01 | Yes | TiO₂ | 57 | 62→54 | |
| 1-3 | Pt | 0.1 | Yes | TiO₂ | 56 | 71→67 | |
| 1-4 | Pt | 5 | Yes | TiO₂ | 52 | 85→84 | |
| 2 | Pt | 0.5 | Yes | CeO₂ | 76 | 70→60 | |
| 3 | Pt | 0.1 | Yes | ZrO₂ | 49 | 66→64 | |
| 4 | Pt | 0.05 | Yes | Al₂O₃ | 77 | 61→57 | |
| 5 | Ru | 0.5 | Yes | ZrO₂/ | 122 | 72→68 | |
| | | | | Al₂O₃ | | | |
| 6 | Rh | 0.1 | Yes | CeO₂ | 75 | 70→68 | |
| 7 | Ir | 0.5 | Yes | Al₂O₃ | 80 | 66→60 | |
| 8 | Pt | 0.05 | Yes | ZrO₂/ | 109 | 65→62 | 65→64 |
| | | | | TiO₂ | | | |
| 9 | Ru | 0.5 | Yes | ZrO₂ | 50 | 71→66 | |
| 10 | Ru | 0.05 | Yes | ZrO₂ | 50 | 72→68 | |
| Comparative | Pt | 0.1 | No | ZrO₂ | 45 | 77→25 | |
| example 1 | | | | | | | |
| Comparative | Co—Mo | | No | Al₂O₃ | 47 | 5 | |
| example 2 | | | | | | | |
| Comparative | Cu—Zn | | No | Al₂O₃ | 58 | <1 | |
| example 3 | | | | | | | |

As shown in Table 2, the catalyst according to the present invention had good activity even at a low temperature (200° C.) In particular, the shift catalyst 1-1 and the catalyst 8 had good CO conversion rates even after exposure to HCl.

By contrast, the CO conversion rate of the comparative catalyst 1 according to the comparative example was significantly reduced or the catalyst was deactivated at the low temperature (200° C.) because the comparative catalyst 1 was not subjected to the sulfuric acid treatment. The activities of the comparative catalysts 2 and 3 were reduced at the low temperature.

Furthermore, the specific surface areas of the catalysts according to the test examples were increased and excellent relative to the comparative catalysts.

Therefore, it is confirmed that the catalysts according to the test examples have good activities at a low temperature. It is also confirmed that the catalysts are useful as a CO shift catalyst that is resistant to halogen.

### INDUSTRIAL APPLICABILITY

As described above, according to the CO shift catalyst of the present invention, it is possible to cause a shift reaction to occur while reducing the amount of steam and saving energy when gasification is performed by a coal gasifier. Therefore, it is possible to provide a highly efficient gas purification process with good thermal efficiency.

1. A CO shift catalyst that reforms carbon monoxide (CO) in a gas, comprising:
one or a mixture of platinum (Pt), ruthenium (Ru), iridium (Ir), and rhodium (Rh) as an active ingredient; and
at least one of titanium (Ti), aluminum (Al), zirconium (Zr), and cerium (Ce) as a carrier for supporting the active ingredient.

2. The CO shift catalyst according to claim 1, wherein the carrier is a complex oxide of at least two types of elements.

3. The CO shift catalyst according to claim 1, wherein an additive amount of the active ingredient is 0.01 to 5% by weight.

4. The CO shift catalyst according to claim 1, wherein the CO shift catalyst is prepared by causing sulfate radical to remain therein.

5. A method of manufacturing a CO shift catalyst comprising:
adding sulfuric acid to an oxide of one of titanium (Ti), aluminum (Al), zirconium (Zr), and cerium (Ce) or to a complex oxide of at least two of titanium (Ti), aluminum (Al), zirconium (Zr), and cerium (Ce);
evaporating moisture from the oxide or the complex oxide to which the sulfuric acid is added at the adding;
firing the oxide or the complex oxide, from which the moisture is evaporated at the evaporating, in a heating furnace at a temperature of 500 to 600° C. to cause sulfate radical to remain in a carrier; and
causing the carrier, in which the sulfate radical remains, to support an active ingredient.

6. The method according to claim 5, wherein
the active ingredient is one of or a mixture of platinum (Pt), ruthenium (Ru), iridium (Ir), and rhodium (Rh).

7. A CO shift reactor comprising a reactor that is filled with the CO shift catalyst according to claim 1.

8. A method for purifying gasified gas comprising:
removing soot and dust from gasified gas containing halide by using a filter, the gasified gas being obtained by a gasifier;
causing a CO shift reaction to occur by using the CO shift catalyst according to claim 1;
cleaning the gasified gas by a wet scrubber after the CO shift reaction; and
removing carbon dioxide from the gasified gas after the cleaning.
